(19) United States
(12) Patent Application Publication
(10) Pub. No.: US 2015/0059101 A1
(43) Pub. Date: Mar. 5, 2015

(54) PORTABLE TOOL FOR SKATEBOARD

(71) Applicant: Daniel R. Talbot, Mitchell, CA (US)

(72) Inventor: Daniel R. Talbot, Mitchell, CA (US)

(21) Appl. No.: 14/479,248

(22) Filed: Sep. 5, 2014

Related U.S. Application Data
(60) Provisional application No. 61/873,921, filed on Sep. 5, 2013.

(51) Int. Cl. B25G 1/08; A63C 17/00; B25B 13/48; B25F 1/00

(52) U.S. Cl. CPC B25G 1/085; B25F 1/00; A63C 17/0006; B25B 13/48
USPC 7/138

(57) ABSTRACT

An example of a portable multifunctional tool for a skateboard is provided and the tool comprises a multi-head wrench, a wrench locking spring to locks the multi-head wrench in a plurality of positions, a rotating screwdriver arm, and an internal housing to hold the rotating screwdriver arm.

### BACKGROUND

Skateboarding is a leisure time activity for a lot of people. As they are use more frequently, skateboards require maintenance. For example, a skateboard may be in competitive events which require jumps and other athletic maneuvers. Accordingly, the skateboard may require adjustment or repair, which requires using socket wrenches of different sizes, a head screwdriver and/or other tools for securing the fasteners which retain the skate on the board, adjusting the axles or alike.

### BRIEF DESCRIPTION OF THE DRAWINGS

Examples are described in the following detailed description and in reference to the drawings, in which:

FIGS. 1A-B illustrate a representation of an example portable tool in accordance with an implementation of the present disclosure; and

FIGS. 2A-D illustrate example combinations of different components of the portable tool shown FIG. 1 in accordance with an implementation.

### DETAILED DESCRIPTION

Various aspects of the present disclosure are directed to a one-piece multifunctional tool for a skateboard. More specifically, and as described in greater detail below, various aspects of the present disclosure are directed to a manner by which a tool for a Skateboard that can be conveniently and without an obstruction be carried by a user in pants, jacket pocket and easily stored and or transported in a bag or small area due to its slim and compact design.

Aspects of the present disclosure described herein disclose allowing the user to carry a multifunctional tool with detachable parts. Among other things, this approach allows to integrate certain components (e.g., screwdriver) into a portable tool, which could not otherwise be integrated. Moreover, aspects of the present disclosure described herein allow provide a lightweight and compact tool. Among other things, this approach may provide a skateboarder who may not want to be burdened by carrying around a tool box or a plurality of tools a tool that can be used to repair or maintain the skateboard.

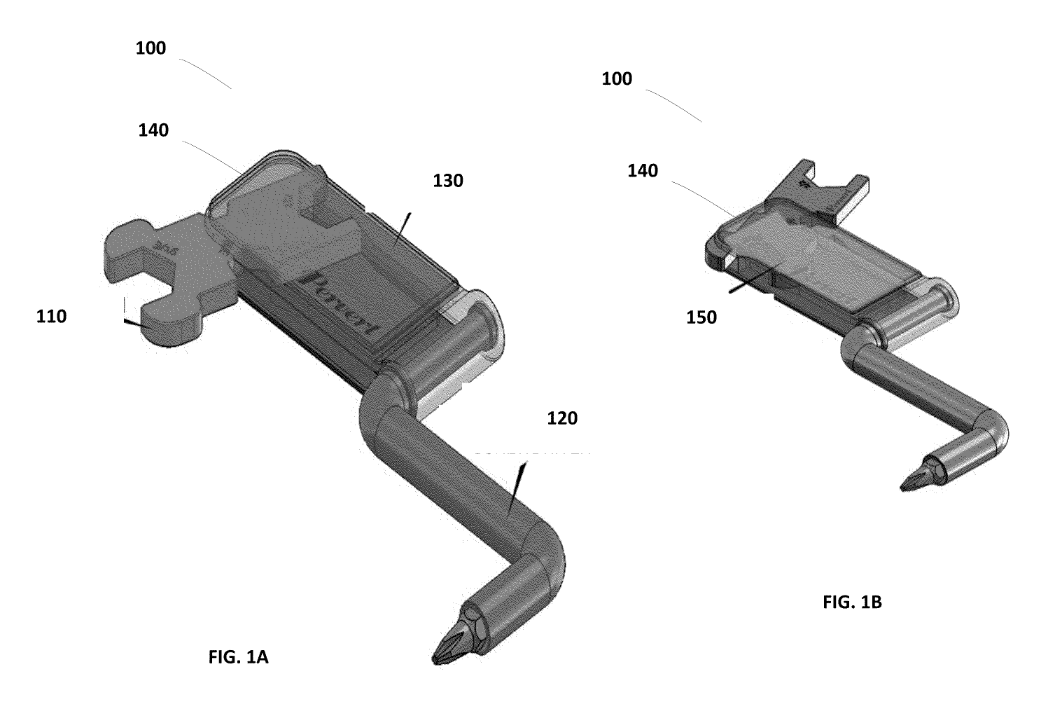

FIG. 1 is a detailed view of an example portable tool 100 that can be used by skateboarder on a skateboard. It should be readily apparent that the present illustration should not be interpreted to be limited by this particular illustrative architecture shown in FIG. 1, and the tool 100 represents a generalized illustration and that other elements may be added or the illustrated elements may be removed, modified, or rearranged in many ways.

The tool 100 has a slim rectangle shaped hallow body for leverage. The body of the tool 100 acts as a storage compartment for a multi-dimensioned wrench 110 which fits all nuts on a complete skateboard assembly, to which the Multi-wrench is held in place by a friction spring. Further, the rectangle body of the tool 100 is attached to a rotating screwdriver arm 120 which makes the tool 100 quicker and easier to use than a conventional fixed arm screw driver tool. The rotating screwdriver arm 120 may have a socket head at the tip. As shown in FIG. 1, the rotating arm 120 extends perpendicular downwards to the rectangle body of the tool 100 and bends parallel to the rectangle body, which then sits perpendicular downward where there is the socket head on the end to accommodate a multi-head Allen and Philips screw driver bit.

In one implementation, the outer case is extended and wrapped around interior structure (e.g., interior housing 130) to increase the rectangular body fully and create a round perpendicular bushing at one end to hold and facilitate the rotating arm.

The tool 100 comprises a plurality of parts as shown in FIGS. 1A and 1B. The external shell case 140 embodies the internal housing 130 and wrench locking spring 150, which creates a storage compartment for the multi-head wrench 110. The multi-head wrench 110 is used to fasten the nuts on the pivot pin of a skateboard known as a “king pin”, the axel or “wheel nut”, the mounting hardware nut, and all other components of a skateboard assembly. Both FIGS. 1A and 1B shows the multi-head wrench 110 in a pulled out position, but the multi-head wrench 110 may also sit in its home position and in the storage compartment, which can be easily pulled out and detached if desired.

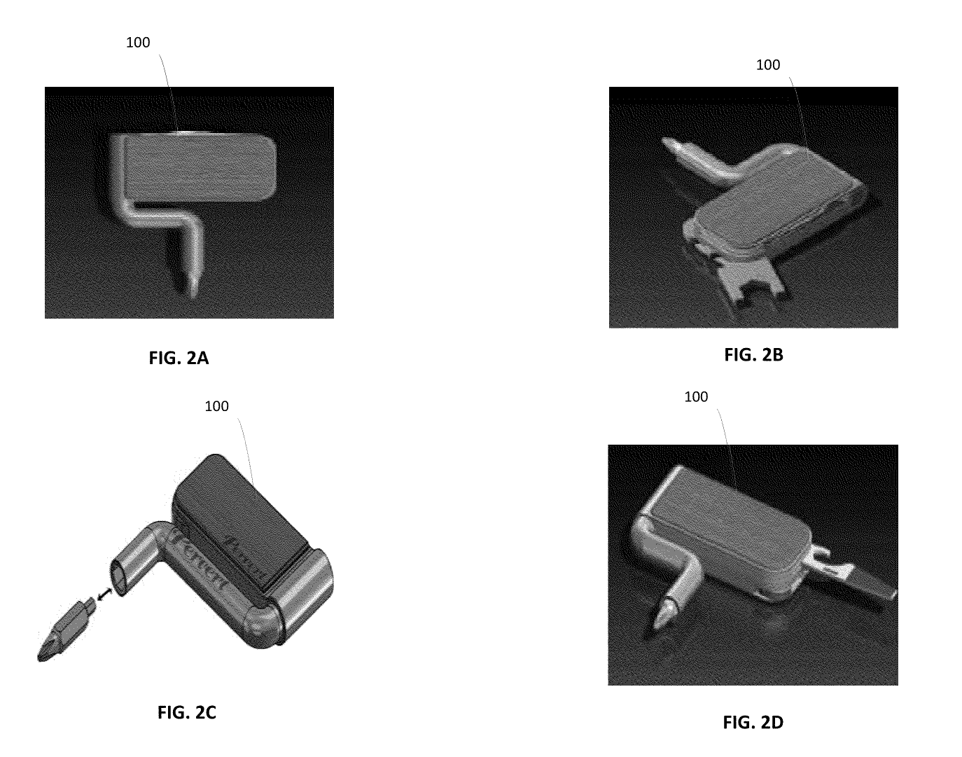

FIGS. 2A-2D illustrate examples of the portable tool 100 of FIG. 1 with various components in different positions. It should be readily apparent that the present illustration should not be interpreted to be limited by this particular illustrative architecture shown in FIGS. 2A-2D, and the tool 100 represents a generalized illustration and that other elements may be added or the illustrated elements may be removed, modified, or rearranged in many ways. For example, one screwdriver is shown as examples, and more or less number of screwdrivers may be shown in another implementation.

Referring to FIG. 2A, the multi-head wrench 110 is locked in the tool 100 and held in its home position and its active positions internally by the wrench locking spring 150. The internal housing 130 is specifically designed to work with the multi-head wrench 110, and locks and holds the multi-head wrench 110 in place during its active use as shown in FIGS. 2B. The external shell case and internal housing create an extension handle to the multi-head wrench 110 and create additional leverage and more comfort during use.

The multi-head wrench 110 locks into the internal locking notches and is held in place by the wrench locking spring 150 in its home as shown in FIG. 2A and active positions as shown in FIG. 2B. The rotating leverage screwdriver 120 and customized design enables the user with a quick and efficient screwdriver to attach the mounting hardware on a skateboard assembly. The rotating leverage screwdriver 120 drastically reduces the traditional assembly time, as all traditional skateboard tools are fixed and non-rotating drivers. Additionally, FIG. 2C illustrates an example where the rotating screwdriver arm 120 may have a socket head at the tip. Further, FIG. 2D illustrates additional components of the tool 100 in active position (e.g., pulled out). In this example, one additional component has been shown, but it should be noted that the tool 100 may have other additional components that are not discussed and/or illustrated herein.

While the above disclosure has been shown and described with reference to the foregoing examples, it should be understood that other forms, details, and implementations may be made without departing from the spirit and scope of the disclosure that is defined in the following claims.

What is claimed is:

1. A portable multifunctional tool for a skateboard, comprising:
a multi-head wrench;
a wrench locking spring to locks the multi-head wrench in a plurality of positions;
a rotating screwdriver arm; and
an internal housing to hold the rotating screwdriver arm.

2. The tool of claim 1, further comprising an external shell case to house the multi-head wrench, wrench locking spring and internal housing.

3. The tool of claim 1, wherein the external shell case and the internal housing form a slim rectangle shaped hallow body.

4. The tool of claim 1, wherein the wrench is a multi-dimensioned wrench which fits all nuts on a complete skateboard assembly.

5. The tool of claim 1, wherein the plurality of positions that the multi-head wrench is held in comprises an open position where the multi-head wrench is pulled out of the housing.

6. The tool of claim 1, wherein the plurality of positions that the multi-head wrench is held in comprises a closed position where the multi-head wrench is in a home position inside the housing.

7. The tool of claim 1, wherein the multi-head wrench is detached from the internal housing and stands independently from the tool.

8. The tool of claim 1, wherein the tool is a portable multi-functional tool used by a skateboarder on the skateboard, wherein the skateboarder carries the tool in pants, jacket pocket or transported in a bag or small area.
